(19) United States
(12) Patent Application Publication
(10) Pub. No.: US 2025/0071406 A1
(43) Pub. Date: Feb. 27, 2025

(54) SYSTEM AND METHOD FOR CAPTURING, COLLECTING, CORROBORATING, AND USING CROWDSOURCED DATA TO ANALYZE EVENTS SUCH AS UAP SIGHTINGS

(71) Applicant: David Coy, Florence, OR (US)

(72) Inventor: David Coy, Florence, OR (US)

(21) Appl. No.: 18/812,943

(22) Filed: Aug. 22, 2024

Related U.S. Application Data
(60) Provisional application No. 63/578,405, filed on Aug. 24, 2023.

(51) Int. Cl. H04N 23/61; H04N 21/4223; H04N 23/661; H04N 23/695

(52) U.S. Cl. CPC H04N 23/61; H04N 23/661; H04N 23/695; H04N 21/4223

(57) ABSTRACT

The present disclosure discloses a system to collect and corroborate data associated with world events, including Unidentified Anomalous Phenomena (UAP) sightings, from a plurality of users. The system includes a transceiver and a processor. The transceiver is configured to receive a request to capture data associated with UAP sightings from a user device. The processor is configured to obtain the request from the transceiver and cause the user device to collect event data such as UAP event data. The processor is configured to obtain a trigger from the user device and transmit a notification to other user devices to collect event data, such as UAP data responsive to obtaining the trigger instruction. The processor is further configured to receive the event data from the user device and other user devices responsive to the transmission of the notification and store the event data, such as UAP data.

### CROSS-REFERENCE TO A RELATED APPLICATION

The present application claims the benefit and priority of U.S. Provisional patent application Ser. No. 63/578,405, filed Aug. 24, 2023, entitled UNIDENTIFIED ANOMALOUS PHENOMENA SIGHTING DATA COLLECTION SYSTEM.

### BACKGROUND OF THE INVENTION

### Field of the Invention

In times such as these, with unpredictable world events, unknown risks, unrealized dangers, and strange occurrences, a reporting and predictive modeling system is useful for education and community engagement for any number of reasons, including safety and security. In all such cases, there is a need for real-time data capture contributions from the public at large in an unbiased manner, ensuring anonymity to protect the data as well as the contributor.

The present invention generally relates to crowdsourced notification and information-sharing systems, and such systems that are specifically suited to capturing observational data associated with the real-time world and human events such as, but not limited to, airborne object sightings, including unidentified (or unknown) aerial phenomena (hereinafter “UAP”) sightings; or even impactful environmental changes; crime; traffic patterns and flow; disease outbreak and propagation; fluctuation and supportive infrastructure demands in civilization and communities; crowd monitoring and control; medical emergency alerting; augmented reality amusement and entertainment; and of course, national security and defense.

More particularly, the claimed invention is directed to the systems mentioned above incorporating a crowdsourced data gathering function using an open network distributed platform enabling a plurality of anonymous users, potentially unlimited in number, to contribute sighting event information data related to the observable events associated with airborne objects and anomalies including Unidentified Anomalous Phenomena (UAP) and the like.

The present invention is believed to have a direct correlation to the safety and security of the citizenry of the nation and community in which such capability is installed and utilized by its citizenry.

### Description of the Related Art

Many people are interested in UAPs and actively study or analyze reports of sighting events. Sometimes, the UAP sighting data is inconsistent or unreliable information upon which collective understanding, albeit scientific, or a response may be formulated or initiated. The lack of consistent and reliable information may be due to a range of factors, for example, variability in reporting, cooperative disclosures, limited research resources, lack of anonymity, an inability to verify an event observed from separate locations simultaneously, improper characterization of the observed event, data capture device shortcomings, and a lack of relational data support. Such factors contribute to an incomplete record of the sightings and, hence, minimal utility of the data due to its anecdotal nature.

Currently, there are no known formal systems for UAP sighting data incorporating a crowdsourced open network coordinated on a platform having distributed data capture and processing capability that is easy to use. The background systems also lack an invitation notification feature alerting the member subscriber devices on the open network resting in a passive mode to “wake up” and look for a potential observational event in their region. The background devices and their relational networks are also incapable of utilizing a plurality of sensor (data) inputs that expand in number in real-time to promote the integrity of the data from a dynamically increasing number of inputs and the corresponding data sources or sharing feedback to the dynamically expanding group in real-time to enhance the reliability in the data associated with the UAP sighting or event being recorded. The background systems also lack a way to discriminate, authenticate, compare captured observational data to relational data sets, or create identification signatures for future reference and enhanced platform performance over time.

Several US and international patent applications are directed to real-time environmental monitoring systems using cameras and a purported use of AI to analyze static environments such as warehouses and building structures. Their purpose is to monitor a static environment for a change in a known control set of static data for security purposes. Those systems, and the background systems like it, do not use a crowdsourced open network with a potentially unlimited number of users with dynamic fluctuations of data inputs and distributed processing resources across the network useful for handling the dynamic data associated with changing events such as moving targets (UAP subjects). Moreover, such systems cannot provide a predictive model and real-time processing driven by the platform's allocation of processing resources, enabling the capture of observational data by a plurality of devices and users varying in sophistication individually. In addition, all such systems are not designed to cooperate with external relational databases for support such as to aid in the capture of observational data, cataloging and archiving the captured data, creating data signatures from the data, and preserving it for future extraction, consideration, and processing should similar events be observed later. Therefore, such background systems are known to report without an assessment (verification, authentication, comparison, correlation, or identification, etc.), such that any feedback is limited to predictable trend analysis and ignores other learning functions associated with unpredictable feedback where artificial intelligence (AI) and machine learning (MI) are considered useful as part of the present invention whenever unexplainable aerial movements are observed, including UAPs for which little is known.

For comparison, conventional observational systems such as radar and other components utilize sensor-based input and may include a plurality of sensor-based inputs. Still, they do not utilize relational database drivers such that system integrity and data capture become more reliable over time. For example, defense systems can track aerial crafts, objects, and phenomena of the expected types because a preconfigured signature is the triggering instruction based on what is known. Responses based on known data are patterned responses that do not require system verification, and un-patterned responses are outside the scope of the system architecture. Therefore, such systems also lack the capability of processing crowdsourced data inputs, incorporating a learning function for identification, formulating an initiative-triggering response or defensive strategy, or coordinating an appropriate response amongst diverse responsive units designated for aerial threats from manmade airborne objects or UAP crafts.

Until now, a platform for using crowdsourced data captured in an open (as to user participation), secure network with a distributed architecture having a virtually unlimited number of users as participants, wherein the network is designed for anonymity of the user while capturing the input data, accessing relational databases for data verification and/or authentication increasing data integrity and promoting real-time correlation with previously observed and recorded events, while enabling threat assessment, has not been invented in the manner disclosed and described herein. For example, there is a need for such a system for the uniform collection of data associated with UAP sightings and national defense.

The system associated with the present invention promotes a faster, more targeted response to previously unknown threats, including the capability to initiate the appropriate response to observable aerial events associated with unknown (unidentified) sources.

### SUMMARY OF THE INVENTION

The following summary of the invention is presented in a simplified form as a prelude to the description and related discussion presented below.

The invention uses anonymous crowdsourcing comprising multi-sensor (user) inputs and user input integration, real-time data processing, AI and MR algorithmic calculations for optimizing feedback generally and patterned responses specifically. The system data processing is facilitated by integration with the inherent system databases and optional relational private, governmental, research, and industrial databases, etc. Real-time notifications based on changes in observable or perceived data conditions (events) such as location, velocity, frequency, intermittence, target probability, trigger the system to notify other network subscribers (triggering instructions), encouraging their participation in capturing data. The user inputs (data captured) may be augmented by device inputs from radar and sophisticated independent monitoring systems to increase data and feedback confidence.

In one general aspect, the present invention addresses the significant challenges associated with collecting consistent and reliable eyewitness data on such occurrences due to variability in device capabilities, inconsistent correlation to the data associated with the observable event, non-cooperating reports of the data collected, an inability to corroborate (discriminate, authenticate, or verify) the data collected, and access additional resources to name a few.

The significance of the crowdsourcing function not only provides variability in perspective as to, for example, the location of the observer in relation to the target (e.g., UAP) but also provides a contributory function for accurate observation, predictability and trend analysis, and extrapolation to unpredictable corresponding events. This analysis also promotes a responsive capability, including responses to unpredictable events, where such data manipulation involves artificial intelligence (AI) and machine learning (ML) algorithms to generate meaningful (useful) reporting needed for appropriate responses. The usefulness of the reports directly correlates to the responsiveness of independent systems initiated by the inventive system, such as in the context of the national security and defense category, but also the educational or amusement arts. The report (feedback) enables the network operators and those in a managerial capacity of the processing platform, residents in a single location such as cloud-based computing or distributed amongst the user devices such as a smartphone application (app), to become better informed and educated regarding expectations, enabling an initiative-taking approach (triggering) that will benefit society as a whole.

In addition, a secure, open, crowdsourced network with a potentially unlimited number of contributors that has a notification component or call-to-alert feedback component (hereafter triggering instructions) is provided to strengthen the consistency and reliability of the data captured in satisfaction with the shortcomings of the background devices as stated above. Enhanced participation enables better correlation between the data inputs and relational databases in all contexts. It provides a sense of personal satisfaction for the engagement by each person who shares the growing interest and concern not only for themselves but for all to be aware of the associated world event.

In general, the platform on which the present invention will be shared and used is a handheld communication device such as a handheld smartphone tablet or properly configured computer with the appropriate peripherals enabling the needed data capture and distribution functionality, interactively connected to a platform for centralized processing, or managed shared processing depending upon such factors as the sophistication of the user device and associated capabilities of it. For example, it is conceivable that one may utilize a handheld smartphone just as easily as an individual would use a stationary desktop computer with peripherals such as a camera with a directional capability such that both devices may be aimed at the event to capture images, sounds, provide some device resident processing for efficiency of the securely connected platform open on the web. In other cases where the user device (transceiver) can capture and transmit data (e.g., legacy cellphones with simple cameras) but do not have the adequate processing capability to support the platform data processing requirements, the platform resident processing performs the processing tasks for them and provides feedback reporting to them.

Therefore, the present invention may be summarized as a system for leveraging data gathered by crowdsourcing; protecting user anonymity; utilizing multi-sensor integration; real-time data processing in resident or distributed modes; advanced algorithms (AI, ML, statistical pattern recognition); robust data integrity corroboration; and enhanced location identification techniques to ensure the systematic and unbiased collection and analysis of time-sequenced capture of events.

By providing a platform that ensures user anonymity and utilizes a wide range of sensors (e.g., the user devices), the invention enhances the reliability and comprehensiveness of airborne object data, thereby facilitating more accurate and evidence-based research and innovation potential as well. The system is, therefore, inherently mobile and can be configured to work in moving vehicles and aircraft.

In addition, the invention provides a robust and comprehensive system for collecting and analyzing airborne object data. The system gathers data from multiple users by leveraging crowdsourcing for a wide coverage of airborne object sightings and geography. The system prioritizes user anonymity, encrypting all collected data and metadata to protect user identities. The integration of multiple ancillary sensors or independent relational databases, including visual, infrared, radar, and educational data archives of virtually any type, all types, enables the collection of diverse data types, which are then processed using, for example, data fusion techniques for comprehensive analysis. The fusion techniques further support the platform's distributed or resident (e.g., cloud-based) real-time data processing.

Real-time data processing ensures immediate feedback and alerts, enhancing the responsiveness of the system and the accuracy of it. The use of AI, ML, and statistical pattern recognition algorithms also allow for advanced data analysis techniques and continuous improvement in the identification accuracy of airborne objects. Thus, the system continuously improves to ensure the reliability of the object identification from the collected data.

To ensure data integrity such as by corroboration, the system employs an authenticator, a discriminator, a comparator, a converter, and a report generator at the data capture and initial processing stages; and advanced security methods such as blockchain storage, checksums for images and metadata, digital signatures if enabled, source-based encryption, certification infrastructure, and a zero-trust security architecture. Additionally, the system enhances location identification through GPS data augmented with star positioning at nighttime, inclinometer, and accelerometer data processing for object triangulation using the tilt angle from these user device sensors for optional advanced tracking capability.

Furthermore, the system provides flexible integration with existing databases or applications for the location of astronomical objects such as stars and planets, weather phenomena, known aircraft, satellites, meteorites, and space debris, enhancing the accuracy of identifying these common phenomena. The system also optimizes image quality by controlling camera settings, including using raw data formats automatically and adjusting, for example, camera exposure times based on lighting conditions and the phone's inherent memory limitations.

The backend platform and associated database store collected airborne object data from multiple user devices while curating and processing the data using advanced algorithms in parallel to the collection. The system identifies and triggers nearby devices (i.e., sends a triggering instruction that is received by the nearby device) capable of participating in crowdsourcing data collection, integrates with stationary sensors such as stationary security camera networks, mono- and bi-static radars, or national emergency signals to provide triggers to user devices for additional crowdsourced data collection, enables real-time communication across multiple potential networks including, for example, but not limited to cellular, Bluetooth, and WiFi or Internet connections for data sharing between user devices. The preferred advanced system provides analytical tools for researchers to access and study curated data of unknown objects in support of their identification.

The elements of the present inventive platform of the system are software-driven and can be summarized in a variety of ways, including a platform having a transceiver configured to receive a request to capture data associated with Unidentified Anomalous Phenomena (UAP) sighting from a user device; a processor communicatively coupled to the transceiver, wherein the processor is configured to obtain the request from the transceiver; cause the user device to collect UAP data; obtain a trigger from the user device; transmit a notification to other user devices to collect UAP data responsive to obtaining the trigger; receive the UAP data from the user device and the other user devices responsive to the transmission of the notification for data corroboration; authenticate, a discriminate, a comparer, a convert, and generate a report of the data; and store the UAP data.

Therefore, the various embodiments of the software application driven system also include any or all of the following: a UAP signature generator for generating UAP signatures from collected UAP data; at least one relational database capable of storing UAP data signatures; an authenticator for authenticating the collected UAP data before transmitting the notification by accessing the at least one relational database and comparing the UAP data collected by the user device to at least one UAP signature; a discriminator operably connected to the UAP signature generator and the at least one relational database for comparing the authenticated collected UAP data to at least one designated UAP signature within the relational database and initiating the creation of a new UAP signature when the authenticated collected UAP data and corresponding signature differs from the designated signature; a comparator for comparing the signatures from the signature generator of a first user device to the signatures generated by the signature generator of a second user device and comparing the signatures to the stored authenticated UAP data and signatures in the at least one relational database, enabling the system to improve the authentications of the UAP data and the subsequent creation of UAP signatures for any given sequence of UAP data-generating events having a common UAP signature associated with a plurality of users; a report generator for generating a report of the authenticated collected UAP data and designated signatures received from a plurality of users corresponding to the same UAP event; and a converter for converting the reported data into user device manipulation instructions and transmitting those instructions to the users to assist them with the collection of additional UAP data associated with the same UAP sighting event.

The user devices comprising a portion of the system preferably include a camera with adjustable camera settings configured to be responsive to the user device manipulation instructions associated with the authenticated data and designated signatures. In addition, the user processors are configured to initiate the adjustment of the user device camera settings in response to the common authenticated data and the designated signatures further comprising a UAP signature recognition algorithm capable of calculating signatures corresponding to UAP movement data and generating UAP movement predictions based on the calculations, and initiating responsive adjustments to the camera settings based on the movement predictions.

A tracker feature is available for producing tracking data responsive to the camera adjustments, enabling the user device camera settings to track UAP movement in accordance with a set of UAP signatures for predictable UAP movements. The advanced processor for making movement predictions is operably configured to be responsive to at least one artificial intelligence (AI) algorithm such that the generated camera adjustments are responsive to non-analogous signatures and authenticated UAP data to anticipate unpredictable movements of the UAP being observed. The unpredictable movements become part of the predictable movement signatures for a previously recorded UAP sighting event wherein the unpredictable movement signature is sent to the user devices as an alternate set of tracking data if the observed UAP is no longer visible to any of the users. The user device camera settings are adjusted to correspond to the alternate set of tracking data received.

A preferred embodiment also includes an advanced report generator for generating a report of corroborated data from the alternate set of tracking data when the user device UAP tracking data is authenticated as capable of tracking the UAP; and a transmitter for transmitting the report to an independently configured responsive system capable of initiating an independent system response commensurate with its function. The report is deemed particularly useful in the context of national security and independently responsive defensive systems.

The automated method of the present invention includes the following software application-driven method (processing) steps, which are not shown as system hardware elements. A summary of one of the preferred embodiments of the inventive method is: a method of capturing, processing, and reporting data associated with Unidentified Anomalous Phenomena (UAP) sightings, by providing a system of user devices capable of capturing moving image data with a user software application configured for capturing UAP sighting data wherein the user device further includes a transceiver for sending and receiving sets of user device instructions consistent with associated with Unidentified Anomalous Phenomena (UAP) sightings and receiving a request to capture UAP data from the user device; providing a processor communicatively coupled to the transceiver, wherein the processor is configured to obtain the request from the transceiver, cause the user device to collect UAP data, generate a trigger signal from a user device, transmit a notification to another similarly configured user device to collect UAP data responsive to the trigger, receive the UAP data from the user device and the other user devices responsive to the transmission of the notification, and storing the UAP data.

The various embodiments also include one or more of the following steps: generating UAP signatures from collected UAP data; storing a UAP data signature in at least one relational database; authenticating the collected UAP data before transmitting the notification by accessing the at least one relational database and comparing the UAP data collected by the user device to UAP signature data within the relational database; generating a UAP signature from authenticated collected data; comparing the signatures from a first user device to the signatures of a second user device and comparing the signatures to the stored authenticated UAP data and signatures in at least one relational database to improve the authentications of the UAP data and the subsequent creation of UAP signatures for any given sequence of UAP data-generating events having a common UAP signature associated with a plurality of users; generating a report of the authenticated collected UAP data and designated signatures received from a plurality of users corresponding to the UAP event; and converting the reported data into user device manipulation instructions and transmitting those instructions to the users to assist them with the collection of additional UAP data.

Some of the various inventive methods are capable of adjusting the user device camera settings in response to the common authenticated data and designated signatures; providing a UAP signature recognition algorithm capable of calculating signatures corresponding to UAP movement data and generating UAP movement predictions based on the calculations, and triggering responsive adjustments to the camera settings based on the movement predictions. The advanced user devices are configured for producing UAP tracking data responsive to the camera adjustments, enabling the user device camera settings to track UAP movement in accordance with a set of UAP signatures corresponding to predictable UAP movements; operable in response to artificial intelligence (AI) algorithms responsive to non-analogous signatures and authenticated UAP data to anticipate unpredictable movements of the UAP being observed; capable of recording the unpredictable movements; storing unpredictable movement signatures for a previously recorded UAP sighting event as predictable; converting the newly stored movement signature into a set of tracking data enabling the user device camera settings to be adjusted to correspond to the tracking data; distributing the tracking data to the users; generating a report from the tracking data when the user device UAP tracking data is authenticated as capable of tracking the UAP; and transmitting the report to an independently configured responsive system capable of initiating an independent system response commensurate with its function.

In accordance with embodiments of the invention, it is an object of this system to collect and corroborate data associated with Unidentified Anomalous Phenomena (UAP) from a plurality of users. The system includes a transceiver and a processor. The transceiver is configured to receive a request to capture data associated with UAP sightings from a user device. The processor is configured to obtain the request from the transceiver and cause the user device to collect UAP data. The processor is further configured to: obtain a trigger from the user device and transmit a notification to other user devices to collect UAP data responsive to obtaining the trigger; receive the UAP data from the user device and other user devices responsive to the transmission of the notification and store the UAP data.

A further object of the present invention is providing a platform to facilitate the collection and corroboration of UAP sighting data using crowdsourcing. The platform is based on a multi-step, multi-user, real-time data capture model and employs readily available smartphone technology (e.g., technology associated with user devices). Since the platform is collecting more visual data and metadata (from multiple users), the platform automatically collects consistent/uniform UAP sighting data during UAP sighting and generates UAP data signatures.

An advantage of the inventive system is the uniform collection of data, corroborating it, and generating (creating) the data signatures, enabling researchers to identify variables, behaviors, and characteristics associated with UAP phenomena. In addition, by collecting and analyzing uniform data, the platform facilitates the identification of correlations between UAP sightings and various variables. By providing uniformly captured UAP data, the platform encourages evidence-based discussions and critical thinking.

A further object and advantage of the inventive platform is it operates independently and maintains user anonymity, minimizing denial and obfuscation. The platform focuses on collecting and presenting objective data free from external influences and bias. In addition, the platform reduces ambiguity and confusion, ensuring systematic recording of UAP information for accurate analysis and interpretation. Further, the platform prioritizes privacy and data integrity, safeguarding against manipulation and ensuring the reliability of collected data.

The platform fosters active participation, raises awareness, and reduces the stigma associated with reporting UAP sightings. In addition, the platform contributes to advancing the understanding of UAP phenomena and differentiating between informed speculation and unsubstantiated claims.

These and other features, aspects, objects and advantages of the present invention will become better understood with reference to the following description.

### BRIEF DESCRIPTION OF THE DRAWINGS

Illustrative embodiments of the present invention are described herein with reference to the accompanying drawings, in which:

FIG. 1 depicts an exemplary environment in which the technique and structure for providing the system and method of the invention;

FIG. 2A-2C depicts a schematic illustrating a process for collecting UAP data via a platform in accordance with embodiments of the invention;

FIGS. 3-6 depict schematic snapshot views of a user interface of a user device, in accordance with embodiments of the invention; and

FIGS. 7A and 7B show the present invention's simplified system process flowchart.

### DESCRIPTION OF INVENTION

### Discussion

The paragraphs of this subsection discuss the attributes of preferred embodiments of the invention in the context of the inventive elements presented in the Summary of the Invention (above).

Crowdsourced data collection. Leveraging crowdsourcing to gather comprehensive and diverse data from multiple users of the present invention (subscribers) is an open network designed for the collaborative inputs from multiple users from their data capture devices (sensors) in a collaborative community setting.

User Anonymity. The system default architecture settings ensure user anonymity thereby encouraging participation by more participants without fear or stigma of reprisal from invasion of privacy. Data reliability is verified by the inventive system such that irrelevant or fraudulent inputs can be detected using relational database comparisons. However, whenever relational databases fall short of the needed authentications, data reliability is protected by the expanse of the open user-crowdsourced network of inputs by comparative analysis of the input similarities to verify data confidence and integrity. This is important when UAP sightings are unexplainable by modern or conventional thinking and resources.

Multi-Sensor Integration. The supporting platform integrates user-acquired additional external sensor inputs to collect rich and diverse data, enabling more accurate analysis and identification of airborne objects. The user application provides uniquely configurable data capture capability to accommodate different device types having, for example, different operational protocols (e.g., PC and Mac). This also allows for the variety of observational devices having diverse functionalities such as memory operating system versions and camera quality, deemed noteworthy for data capture corresponding to tracking, UAP configuration, etc., where processor capability and other advanced features aid the user with feedback.

Real-Time Processing. The system processes data in real-time, providing immediate feedback, notifications, and alerts, crucial for timely airborne object tracking and analysis. Real-time processing includes time-of-event capture details such that changes in any of the initial parameters (designated signatures) are recognized and recorded as changes in a previous event and treated as a new event, enabling unexpected anomalies to be recorded instantaneously at the time of the event. Thus, the system reliability permits greater consideration to be given to data inputs from sensors “having a better picture” post deviation from the previous data collection associated with a single sensor/user to enhance data authentication.

Advanced Algorithms. In the preferred embodiment, the system uses AI and/or ML algorithms and statistical pattern recognition for the most reliable and consistent data analysis such as pattern recognition with continuous improvement in detection accuracy.

The advanced algorithms enable superior processing and fault reduction from time-delayed image capture (ghosting), object and atmospheric shadowing, cloud cover, or even changes in fluid density (e.g., air/atmosphere and rain), and the like.

Data Integrity. The preferred embodiments use methods such as blockchain storage, checksums, opt-in digital signatures, source-based encryption, certification infrastructure, and zero-trust security to ensure data integrity and authenticity, preventing data tampering and enhancing trustworthiness.

Enhanced Stationary Location Identification. Utilizing GPS data augmented with star positioning at nighttime, shadow analysis during daytime, and triangulation with inclinometer information to determine the location and movement of airborne objects accurately, the system enables the user to stay on track of the UAP. The enhanced stationary location information is not limited to distance or position quantification because ground-based sensors will involve commensurate scale adjustments based on land-based geography for more detailed mapping. By comparison, drone-mounted cameras for data acquisition in heavily wooded areas may be used, thereby requiring sensor settings configured to accommodate drone vehicle movements with the commensurate data authentications and related camera adjustments (compare translational and rotational coordinate systems, e.g., Coriolis) requiring a different sensor/camera setting. Hence, stationary location is a relative term. For example, regarding an alternate embodiment, security applications involving large crowds can be analyzed from any number of vantage points monitored by different users with different ground-based or aerial points of view to minimize visual weaknesses and enhance blind spot detection, responsive deployments of personnel, and improved security overall.

Enhanced Moving Sensor Location Identification. The system utilizes GPS data augmented with a phone's inclinometer and accelerometer if in motion and augmented with an aircraft's (e.g., airlines and drones) flight information if in flight to support the integration of an aircraft's flight data. Enhanced sensor location can include surface-to-air linkage that changes if the aerial phenomena are perceived to be moving out of range and defer to an alternate ground-based sensor for primary communication and guidance. This feature may be quite useful in air defense applications where the UAP or airborne object is manmade “of this earth” and might be deemed to pose a security threat, and its targeted destination is not easily discerned from its in-flight detectable path.

Integration with Existing Relational Databases. Integrating databases and applications providing the location of astronomical objects, weather phenomena, known aircraft, satellites, and meteorites, enhancing accuracy in filtering out common phenomena is within the scope of the preferred embodiments of the present invention. Integrations with existing databases are deemed particularly useful to reduce errors and identify previously unknown craft that have a comparative relation to signature data that has been previously cataloged.

Such comparative capability permits extrapolations to known technology. When the observed data and corresponding UAP (or non-UAP) signature differs from that which was previously recorded, the observations can be stored as a delta set of information such that identification of two known phenomena can be made or a new signature recorded. With multiple sensor inputs from various users and locations within the crowdsourced, secure, open network, should there be a high correlation between a new signature and data signature already stored, unknown capabilities can be investigated. In this way, should the observed UAP be observable again at a distinctive time later, the unknown capability set can be relied upon to create defensive strategies as appropriate.

Optimized Image Quality. The preferred system can also control camera settings to optimize image quality using raw data recognition to automatically adjust exposure times based on lighting conditions and the phone's camera capabilities. Therefore, camera and image capture settings can be adjusted based on the known signatures referenced previously. For example, if a certain UAP is observed at two separate times exhibiting a comparable signature for a subsequent event, the unknown capabilities become predictable such that better image capture can add a higher reliability authentication score to the image captured based on the repeated events disparate in time. Moreover, where such repeated events identify a formerly unknown signature, a new class of UAP or event enables a quicker response should one be required.

Backend Database and Platform. The preferred system uses a robust backend platform to optimize and facilitate the identification and notification of nearby devices for crowdsourcing and provides analytical tools for researchers to investigate unknown phenomena. Backend databases and platforms can be used to compile information and generate source predictions such that a better understanding of unknown technology can begin at the moment of data capture based on expectations without close visual inspection.

For example, if atmospheric conditions are also measurable from a supporting relational database standpoint, platform adjustments such as accommodations for velocity changes or deviations can be made from expected path data based on previously captured signatures, radar data, the reflectance of light, or RF signal feedbacks, and other conventional identification technologies.

Integration with Stationary Sensors. As mentioned previously, the open network architecture enables integration with stationary sensor networks, security cameras, and mono-static and bi-static radars to provide triggers for crowdsourcing additional data collection. Such integration with stationary center sensors may be particularly useful in defensive applications including Iron Dome and other national security infrastructure capabilities. For example, considering the size of the United States, such aspects may be particularly useful because of the country's large border compared to other nations with relatively small borders and identifiable vulnerabilities contained within a small geographical area. In such a way, should multiple ground-based user sensors report and offer observable data for secured systems to respond, the response time and accuracy of the appropriate response in both strength and means is better tailored to the situation, and the system is prevented from becoming overwhelmed should multiple events occur at the same time.

Mobility. A significant advantage of the present invention is the unlimited mobility of the open network and positioning of the sensors, whether they be ground-based or airborne, such that guidance of observational sensors for determination of the appropriate response and responsive deployments may be correctly integrated should the need arise. For example, when tracking becomes fragmented or difficult if a UAP maneuvers in a highly unpredictable manner or enters a fluid space having a different density from its previous flight, such as air-to-water submersion. The system is alerted to scan for the pop-up of the UAP back into the air as an alternate tracking path.

Ideally, the system is not only user-friendly and intuitive but also provides feedback to the user confirming reliable data capture and appreciation of its importance. Thus, the system is designed to increase usage, which in turn increases the number of observably recordable events, enhancing security monitoring and response. In turn, the system becomes more dependable and easier to use as the open network expands as a benefit for all users. Such opportunities enable the verification of eyewitness accounts independently and the data capture authenticated to provide better data signature descriptions as an improvement over existing data and signatures. Notably, such signatures may originate from many eyewitnesses, and each may have a unique perspective as to the details they provide, but a common theme should merge because of the enhanced reliability of the signature feedback transmitted to all users/sensors.

### REFERENCE TO THE FIGURES

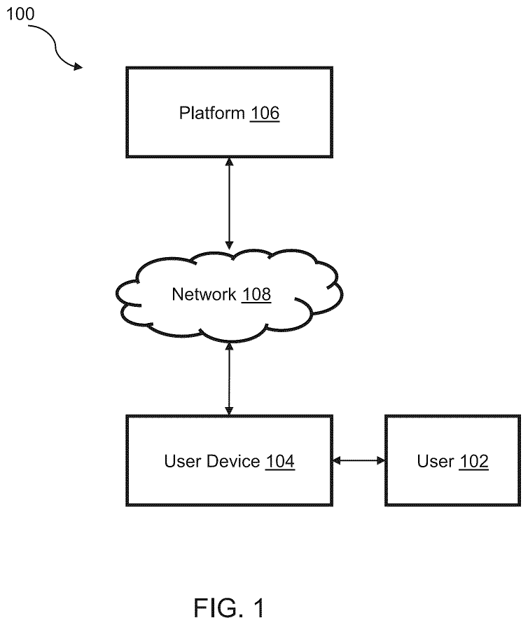

FIG. 1 depicts an example environment 100 in which the techniques and structures for providing the systems and methods disclosed herein may be implemented. The environment 100 includes a user 102 associated with a user device 104. The user device 104 is a mobile phone, a tablet, a laptop, or any similar device having communication capabilities. The user device 104 is communicatively coupled with a platform 106 via a network 108. In a preferred embodiment, platform 106 is an Unidentified Anomalous Phenomena (UAP) sighting platform to facilitate users 102 to capture data associated with UAP sightings/events. In addition, platform 106 encourages multiple users 102 to participate in gathering UAP sighting data.

In a preferred embodiment, platform 106 is hosted on a server (not shown) configured to collect crowdsourced visuals and metadata on the UAP. In addition, platform 106 is configured to perform various operations/analyses on the collected data, including, but not limited to, corroboration (e.g., authentication, discrimination, comparison, conversion, signature creation or identification, and report generation); observable event triangulation; bearing intersections; tracking; polling users for validation of anomalous characteristics; and/or the like. Such data collection, corroboration, and operations/analysis enhances the research and understanding of the phenomena.

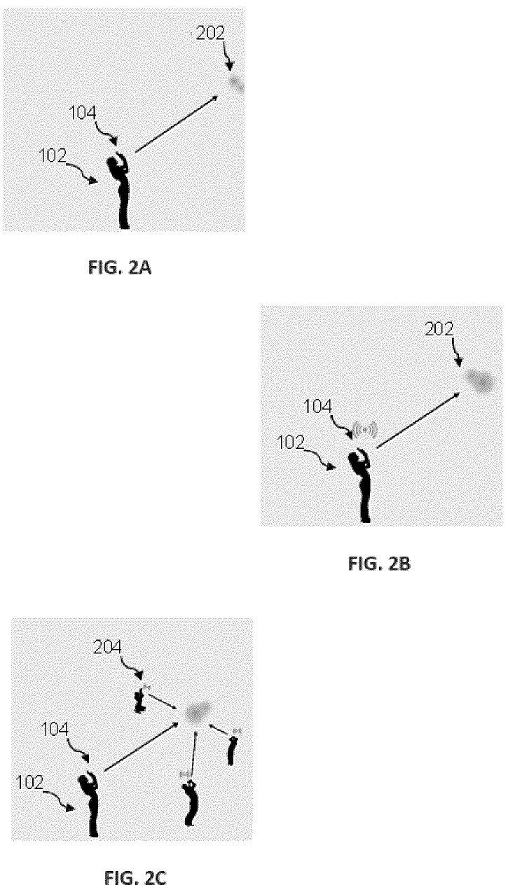

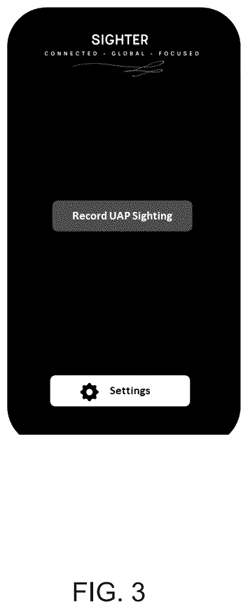

FIGS. 2A-2C depicts a process 200 to collect UAP data via a platform (e.g., platform 106) in accordance with embodiments of the invention as summarized, described, or claimed herein. FIGS. 2A-2C will be explained in conjunction with FIGS. 3-6. FIGS. 3-6 depict snapshots of a user interface of user device 104, in accordance with embodiments of the invention.

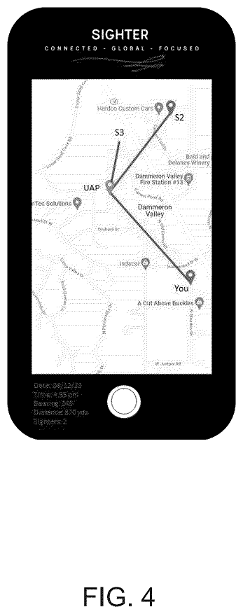

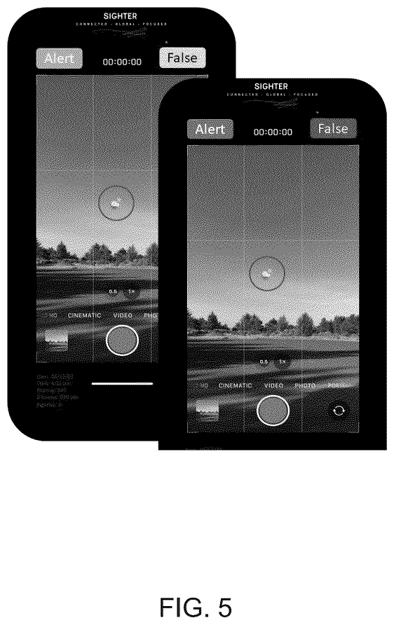

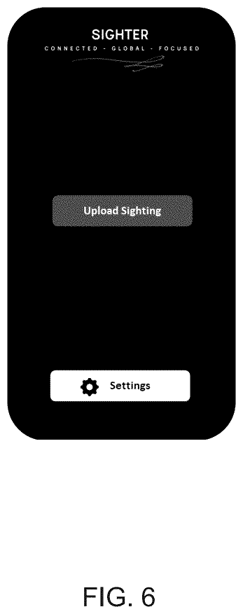

When user 102 detects a UAP 202, user 102 transmits (via the user device 104) a request to platform 106 to capture/record information associated with the UAP sighting (shown as in FIG. 2A, and FIG. 3). Platform 106 (e.g., a transceiver of the platform 106, not shown) may receive the request. Responsive to receiving the request, platform 106 (e.g., a processor associated with platform 106, not shown) may initiate data collection. In some aspects, platform 106 may collect initial data (via the user device 104) including, but not limited to, photographs, videos, and the azimuth/compass bearing to the UAP 202, video metadata, date, time, and user device location by Global Positioning System (GPS), as shown in FIG. 4. User 102 may then begin to record visual data of the sighting via platform 106 and upload the recording (as shown in FIGS. 5-6). In some aspects, platform 106 (or the processor) may track the estimated direction of travel during the sighting, if any, and estimate the distance from the user 102. Platform 106 may then store the captured data and the estimated direction of travel and distance in the memory associated with platform 106. In further aspects, platform 106 (or the processor) may assign the sighting a unique identifier (ID).

User 102 initiates transmitting an alert (or a trigger instruction) to the first set of users 204 (via platform 106, as shown in FIG. 2B). The user devices of the first set of users 204 are communicatively coupled to platform 106. Platform 106 is configured to determine/select users that may be located near user 102 (using the location of the user device 104 and proximity/distance to the UAP 202) and transmit the alert/trigger instruction to the selected users (or the first set of users) to collect UAP data. The alert may include information such as distance, bearing, and azimuth data from the user 102/user device 1-4. The first set of users 204 may receive the trigger instruction as an alert along the above-mentioned information from user 102 (via respective user devices) and launch platform 106 on their respective user devices and point the respective user devices to the UAP location (as shown in FIG. 2C). The first set of users 204 acquire data associated with the UAP 202 via platform 106 and transmit an alert to a second set of users, creating a swarming effect to capture more data associated with the UAP 202. Platform 106 obtains the data associated with the UAP 202 from user device 104 and user devices associated with the first set of user 204 and stores it in the memory of platform 106.

Platform 106 calculates bearing and distance from the subsequent alerted user(s) to the UAP 202, allowing them to visually acquire the UAP 202. Alerted users may not have to physically move to optimize their sighting unless there are obstacles obstructing their view. Platform 106 (or the processor of platform 106) assigns each sighting a unique identifier (ID), and is configured to collect UAP data from multiple users (including user 102 and the first set of users 204) to determine the precise location and trajectory of the UAP 202. When platform 106 receives the UAP data from multiple users, it encrypts and analyzes the UAP data store metadata associated with the sightings on a blockchain as a safeguard against post-sighting modification or tampering.

Platform 106 may use a sighting reticle on its video recording screen to enhance bearing alignment and create intersections, pinpointing the UAP's location. In a preferred embodiment platform, 106 polls smartphones' compasses (or user device's compasses) to obtain shifting bearings during the sighting, synchronizing with the smartphones' clocks. Combining these inputs allows the system to intersect multiple bearings, reconstructing the UAP's path dynamically.

For example, after UAP distance is determined, the system prompts users to enter the estimated elevation angle of the UAP from their respective positions (e.g., by using simple heuristics). A device-based third-party API-enabled inclinometer function incorporated into the system software automatically measures the elevation angle. The estimation (or directly measured elevation angle by software-enabled inclinometer), combined with the distance, allows platform 106 to approximate the UAP's altitude above ground level.

The system authenticates the sighting data in the preferred embodiment and flags non-anomalous sightings. Sightings identified as false positives are kept as references to assist with signature definition and exclude false positives.

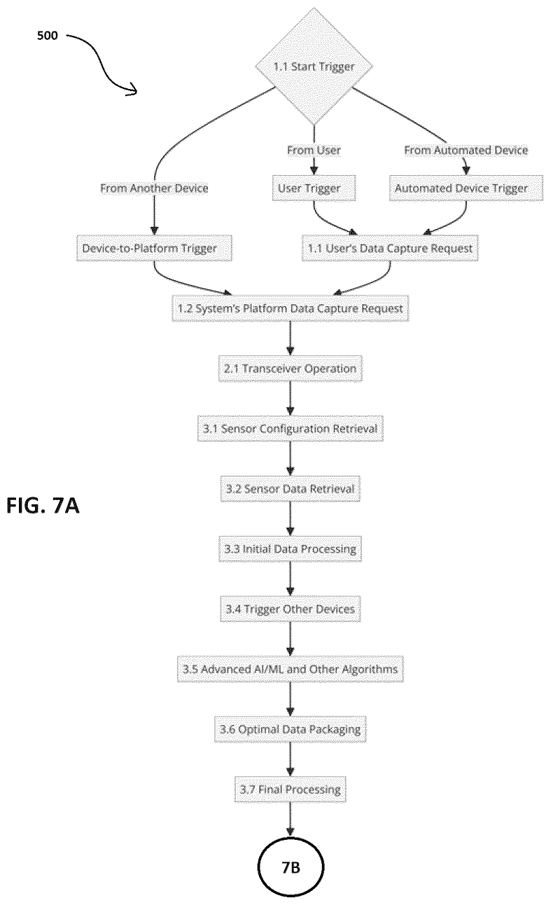

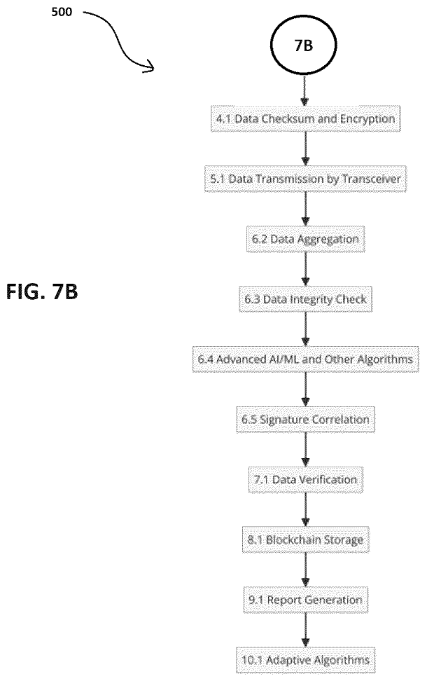

With reference to FIGS. 7A and 7B, the processing functions associated with the inventive system are disclosed in a list resembling a process flowchart format. The associated processing is designated generally by the reference numeral 500. (The numerical references contained in the Figures are used for categorization and are not necessarily intended to indicate the processing sequence of the categories unless otherwise indicated or as claimed).

Process flow 500 outlines the core system's comprehensive steps, from the initial data capture by user devices to the final reporting and system improvement. It emphasizes the system's ability to leverage crowdsourced data, ensure data integrity through corroboration (not shown), and utilize advanced algorithms to analyze and authenticate sightings. It is to be understood as permitting simultaneous (parallel) processing, and distributed or cloud-based processing as well based of several functions limited only by the system hardware capability, process logic, and security requirements requiring sequential processing.

### Concerning User Device Interaction.

1.1 User's Data Capture Request: The process begins when a user or an automated user device identifies an unknown airborne object or UAP (Unidentified Anomalous Phenomena). The user or automated user device sends a trigger to the system's platform to identify and send a trigger to other user devices in the local area. The user or automated user device initiates a request to begin capturing all relevant data (images, videos, GPS coordinates, sensor, and metadata) using the device's sensors (e.g., smartphone, tablet, or other device). Captured data is optimized by the device's processor for transmission back to the system's platform and correlated by a unique time stamp and location id for further processing.

1.2 System's Platform Data Capture Request: The process begins when a user device notifies by a trigger that a user device that an airborne object or UAP (Unidentified Anomalous Phenomena) is in the area. The initiating user device initiates a request to begin capturing all relevant data (images, videos, GPS coordinates, sensor, and metadata) using their device (e.g., smartphone, tablet, or other device) after observing the object. Captured data is optimized by the device's processor for transmission back to the system's platform and correlated by a unique time stamp and location for further processing.

### Concerning Data Collection by the Transceiver.

2.1 Transceiver Operation: A signal request is received from but not limited to the mobile phone network, WiFi, the internet, or Bluetooth by a transceiver in the system, which triggers a user device to automatically start collecting all relevant data (images, videos, GPS coordinates, sensor, and metadata) for that device. The transceiver ensures that all relevant data (images, videos, GPS coordinates, sensor, and metadata) are captured from the user device and sent to the processor for further operations.

### Concerning Processor Operations.

3.1 Sensor Configuration Retrieval: The processor uses an on-device database of attached sensors and device capabilities with optimal configuration settings

3.2 Sensor Data Retrieval: The processor turns on all attached sensors using the optimal configuration settings and collects all relevant data (images, videos, GPS coordinates, sensor and meta data).

3.3 Initial Data Processing: All relevant collected data (images, videos, GPS coordinates, sensor and meta data) is then sent to the user device's on-device processor. The processor performs initial data processing, which includes data filtering, format conversion, authentication, discrimination, and preparation for further advanced analysis.

3.4 Trigger Other Devices: If the initial data processing determines the airborne object or UAP sighting to be of interest, the processor sends a notification to other nearby user devices via the system's backend platform, triggering them to start collecting additional data.

3.5 Advanced AI/ML and Other Algorithms: The processor uses the on-device database of optimal configuration settings to determine if the on-device processor is capable of advanced algorithmic processing. If capable, advanced AI/ML and other algorithms such as but not limited to statistical image processing, pattern matching, Bayesian analysis and others analyze the aggregated data, verify the authenticity of the sighting, and classify the object or phenomenon as known, or unknown. This includes comparing the data with existing “signatures” stored in other databases.

3.6 Optimal Data Packaging: Once the relevant data is processed, the processor identifies an optimal schedule for transceiver transmission operations.

3.7 Final Processing: Once the relevant data is processed, the processing or a cryptographic co-processor performs Data Checksum and Encryption operations.

### Concerning Data Checksum and Encryption (Data Security).

4.1 Data Integrity Measures: Cryptographic methods such as full data encryption or cryptographic checksums, using any of the various cryptographic approaches, or digital signatures are applied, for example to all the relevant data, or just the data's checksum value and then encrypted to ensure that the validity of the data remains secure and unchanged.

### Concerning Data Transmission by Transceiver.

5.1 Transceiver Operation: The transceiver ensures that all relevant data (images, videos, GPS coordinates, sensor and meta data) are scheduled for optimal and timely transmission from the user device to the system processor for further operations. If the user device is triggering additional local devices, minimal relevant data is sent to the system processor as rapidly as possible.

### Concerning System Data Aggregation and AI/ML Analysis.

6.1 User Device Triggering: The system processor prioritizes triggering requests for the participation of other devices based on minimal location information from the requesting user device.

6.2 Data Aggregation: The system processor aggregates data from multiple user devices based on a unique event, creating a comprehensive dataset for further processing.

6.3 Data Integrity Check: The integrity of the processor aggregated data from multiple user devices is confirmed using, for example, a public key data integrity infrastructure to confirm the authenticity of the user device and the data captured.

6.4 Advanced AI/ML and Other Algorithms: Advanced AI/ML and other algorithms, including but not limited to statistical image processing, pattern matching, Bayesian analysis, and others, analyze the aggregated data, verify the authenticity of the sighting, and classify the object or phenomenon as known, or unknown. This includes comparing the data with existing “signatures” from other data providers.

6.5 Signature Correlation: Signatures in other online data providers can include but not limited to matching triangulated location information with online aircraft and satellite location data from other online data providers, correlating electromagnetic radiation and other signatures such as from an object's ‘blinking’ pattern and other captured sensor data including but not limited to spectrometers, GPS, magnetometers and others.

### Concerning Relational Database Comparison.

7.1 Data Verification: The processed data is compared against signatures in the relational databases. This step is crucial for authenticating the sighting and ensuring data integrity.

7.2 Unknown Signatures: If the data does not match any existing signatures, a new data signature is created and added to the database, enriching the system's knowledge base.

These signatures, having a significant probability of being of unknown origin are immediately flagged and reported to system administrators and data analysts for further study.

### Concerning Data Storage and Encryption (Data Security).

8.1 Blockchain Storage: The verified and processed data, along with any new signatures, are stored securely using blockchain technology to document data access requests and processing performed and to prevent tampering.

8.2 Data Integrity Measures: Cryptographic methods like checksums and digital signatures are applied to ensure that the data remains secure and unchanged in storage.

### Concerning Reporting and Feedback.

9.1 Report Generation: The system generates reports based on the analyzed data, which can include predictive analytics about the object's behavior.

9.2 User Notifications: These reports, along with any relevant findings, are transmitted back to the original user and other participating users. Additionally, the system might send feedback or instructions for further data collection or monitoring.

### Concerning Continuous Learning and System Improvement.

10.1 Adaptive Algorithms: The system continuously improves by integrating new data and feedback loops, refining its AI/ML and other algorithmic identification and data processing models to enhance future analytical capabilities.

These and other embodiments of the present invention, as set forth in the preceding description, are contemplated to be within the scope of the present invention which is limited only by the appended claims.

Other Independent Systems in Non-Analogous Fields where the Application of the Invention May be Useful

The following examples indicate perceived utility (uses) beyond that which is disclosed and claimed herein. Each application (use example) differs due to the uniqueness of the data captured, the data configurations, and the supporting relational databases associated with the specific application and data. Therefore, they are not considered to be within the scope of the relevant art whose only limitation is the scope of the appended claims provided below.

Natural Disasters—Real-Time Environmental Monitoring: A system for real-time monitoring and reporting of natural disasters (earthquakes, floods, wildfires, storms) using crowdsourced data. AI can be used to analyze crowdsourced images and videos to detect structural damage during natural disasters. Crime and Security—Crowdsourced Crime Reporting: A system that uses real-time data from multiple users to report and verify suspicious activities, theft, vandalism, and missing persons. Ensures user anonymity while reporting crimes, integrating AI for data verification and reducing false reports. Traffic and Transportation—Predictive Traffic Management: A system that leverages crowdsourced data to report traffic accidents, congestion, and hazards. Uses real-time data and AI to predict traffic congestion and suggest alternative routes. Environmental Monitoring—Crowdsourced Pollution Tracking: A system for real-time reporting and tracking of pollution incidents (air, water, soil) using crowdsourced data. A platform that crowdsources sightings of wildlife to monitor biodiversity, endangered species, and invasive species. A system for real-time data collection on environmental phenomena (climate change, pollution, biodiversity) using crowdsourcing. Public Health: A crowdsourced platform for reporting symptoms and cases of contagious diseases, integrating AI for outbreak prediction. A real-time system for identifying and reporting potential health hazards (contaminated water sources, air quality issues). Community and Infrastructure—Public Works Optimization: A system for real-time reporting of infrastructure issues (power outages, water leaks, public works problems) using crowdsourced data. Uses real-time data to optimize the response and repair of public works issues. Public Gatherings and Events—Crowd Density Monitoring: A system for real-time monitoring of crowd density at large events to ensure safety, integrating AI to predict potential risks. Uses crowdsourced data to report and manage incidents during large public events (protests, demonstrations). Terrorism and Threats—Suspicious Package Detection: A real-time platform for reporting unattended or suspicious packages in public places, using AI for threat assessment. A system for real-time reporting and verification of potential threats and dangerous activities. Emergency Response—Real-Time Medical Emergency Alerting: A system for immediate alerts and coordination of medical emergencies in public places. Uses crowdsourced data for reporting and monitoring fire incidents in real-time. Scientific Research: A platform to facilitate large-scale citizen science projects, integrating crowdsourced data for scientific research. Gaming and Amusement: A location-based AR platform for creating immersive gaming experiences with real-time notifications and challenges. A real-time interactive narrative system based on user location and choices, integrating AR for enhanced engagement. Policing—Real-Time Crime Reporting and Response: A platform for real-time reporting of crimes and suspicious activities, integrating crowdsourced data and AI for rapid response. Facilitates community-driven neighborhood watch programs with real-time alerts and engagement.

What is claimed is:

1. A software application driven system comprising:
a transceiver configured to receive a request to capture data associated with Unidentified Anomalous Phenomena (UAP) sighting from a user device; and
a processor communicatively coupled to the transceiver, wherein the processor is configured to:
obtain the request from the transceiver;
cause the user device to collect UAP data;
obtain a trigger from the user device;
transmit a notification to other user devices to collect UAP data responsive to obtaining the trigger;
receive the UAP data from the user device and the other user devices responsive to the transmission of the notification; and
store the UAP data.

2. The system of claim 1, further comprising:
a UAP signature generator for generating UAP signatures from collected UAP data; and
at least one relational database capable of storing UAP data signatures.

3. The system of claim 2, further comprises:
an authenticator for authenticating the collected UAP data before transmitting the notification by accessing the at least one relational database and comparing the UAP data collected by the user device to at least one UAP signature.

4. The system of claim 3, further comprising:
a discriminator operably connected to the UAP signature generator and the at least one relational database for comparing the authenticated collected UAP data to at least one designated UAP signature within the relational database and initiating the creation of a new UAP signature when the authenticated collected UAP data and corresponding signature differs from the designated signature.

5. The system of claim 4, further comprising:
a comparator for comparing the signatures from the signature generator of a first user device to the signatures generated by the signature generator of a second user device and comparing the signatures to the stored authenticated UAP data and signatures in the at least one relational database, enabling the system to improve the authentications of the UAP data and the subsequent creation of UAP signatures for any given sequence of UAP data-generating events having a common UAP signature associated with a plurality of users.

6. The system of claim 5, further comprising:
a report generator for generating a report of the authenticated collected UAP data and designated signatures received from a plurality of users corresponding to the same UAP event.

7. The system of claim 6, wherein:
a converter for converting the reported data into user device manipulation instructions and transmitting those instructions to the users to assist them with the collection of additional UAP data associated with the same UAP sighting event.

8. The system of claim 7, wherein the user device includes:
a camera with adjustable camera settings configured to be responsive to the user device manipulation instructions associated with the authenticated data and designated signatures.

9. The system of claim 8, wherein the processor is configured to initiate the adjustment of the user device camera settings in response to the common authenticated data and the designated signatures further comprising:
a UAP signature recognition algorithm capable of calculating signatures corresponding to UAP movement data and generating UAP movement predictions based on the calculations, and triggering responsive adjustments to the camera settings based on the movement predictions.

10. The system of claim 9, further comprising:
a tracker, for producing tracking data responsive to the camera adjustments, enabling the user device camera settings to track UAP movement in accordance with a set of UAP signatures for predictable UAP movements.

11. The system of claim 9, wherein:
the processor for making movement predictions is operably configured to be responsive to at least one artificial intelligence (AI) algorithm such that the generated camera adjustments are responsive to non-analogous signatures and authenticated UAP data to anticipate unpredictable movements of the UAP being observed and the unpredictable movements become part of the predictable movement signatures for a previously recorded UAP sighting event wherein the unpredictable movement signature is sent to the user devices as an alternate set of tracking data if the observed UAP is no longer visible to any of the users; and
the user device camera settings are adjusted to correspond to the alternate set of tracking data received.

12. The system of claim 11, wherein:
the report generator generates a report from the alternate set of tracking data when the user device UAP tracking data is authenticated as capable of tracking the UAP; and
transmits the report to an independently configured responsive system capable of initiating an independent system response commensurate with its function.

13. The system claim 12, wherein the independently responsive system is:
a defensive system.

14. A software driven system for capturing, processing, and reporting data associated with observed events, including Unidentified Anomalous Phenomena (UAP) sightings, comprising:
a transceiver configured to receive a request to capture data associated with crowdsourced sighting data from a plurality of user devices within a crowdsourced network; and
a processor communicatively coupled to the transceiver, the processor is configured to:
obtain the request from the transceiver;
cause the user device to collect event data;
obtain a trigger from the user device;
transmit a notification to other user devices to collect event data responsive to obtaining the trigger;
receive the event data from the user device and the other user devices responsive to the transmission of the notification; and
store the event data.

15. The system of claim 14, wherein the processor is configured to access at least one relational database having a plurality of event data signatures, and further comprises
a comparator for comparing the event data collected by the user device to the data signatures of the relational database; and
an authenticator for authenticating the collected event data prior to transmitting the notification and receiving a trigger.

16. The system of claim 15, further comprises:
a signature generator for creating a new event signature when at least one designated signature within the relational database differs from similar data within the collected and authenticated event data; and
storing the authenticated event data and the newly created signature within the at least one relational database.

17. The system of claim 16, wherein:
the transceiver distributes the newly created data signature to the other user devices.

18. The system of claim 16, wherein the signature generator further comprises:
a discriminator for discriminating between signatures obtained from different user devices and comparing them to the stored authenticated event data and signatures before updating the at least one relational database with the newly collected authenticated data and corresponding signatures enabling the processor to improve the authentications of the event data and the subsequent creation of event signatures for any given sequence of event data-generating events having a common signature associated with a plurality of users.

19. The system of claim 18, further comprising:
a report generator for generating a report of the common authenticated event data or designated signatures received from a plurality of users corresponding to the event.

20. The system of claim 19, wherein:
the processor converts the reported data into user device manipulation instructions and transmitting those instructions to the users to assist them with the collection of additional event data.

21. The system of claim 20, wherein:
the user device includes a camera with adjustable camera settings configured to be responsive to the device manipulation instructions received; and
adjusting the user device camera settings in response to the common authenticated data or the designated signatures.

22. The system of claim 21, wherein the processor is responsible for adjusting the user device camera settings in response to the common authenticated data or the designated signatures further comprises:
an event signature recognition algorithm capable of calculating signatures corresponding to pre-designated changes in continuous event data and generating event change predictions based on the calculations; and
triggering responsive adjustments to the camera settings based on the change predictions.

23. The system of claim 22, wherein:
the responsive adjustments to the camera settings based on the change predictions enable the user device camera settings to track the event changes in accordance with a set of signatures for predictable event changes.

24. The system of claim 23, wherein:
the event change predictions are based upon at least one artificial intelligence (AI) algorithm such that the generated camera adjustments are responsive to non-analogous signatures or authenticated event data in order to anticipate unpredictable event changes and the unpredictable event changes become part of the predictable change signatures for a previously recorded sighting event;
the unpredictable event signature is sent to the user devices as an alternate set of monitoring data if the observed event is no longer visible to any of the users; and
the user device camera settings are adjusted to correspond to the alternate set of monitoring data received.

25. The system of claim 24, further comprises:
a report generator for generating a report from the alternate set of monitoring data when the user device monitoring data is authenticated as capable of monitoring the event;
a transmitter for transmitting the report to an independently configured responsive system capable of initiating an independent system response commensurate with its function.

26. An automated method of capturing, processing, and reporting data associated with Unidentified Anomalous Phenomena (UAP) sightings, comprising the following steps:
providing a system of user devices capable of capturing moving image data with a user software application configured for capturing UAP sighting data wherein the user device further includes a transceiver for sending and receiving sets of user device instructions consistent with associated with Unidentified Anomalous Phenomena (UAP) sightings and receiving a request to capture UAP data from the user device;
providing a processor communicatively coupled to the transceiver, wherein the processor is configured to obtain the request from the transceiver, cause the user device to collect UAP data, generate a trigger signal from a user device, transmit a notification to another similarly configured user device to collect UAP data responsive to the trigger, receive the UAP data from the user device and the other user devices responsive to the transmission of the notification, and storing the UAP data.

27. The method of claim 26, further includes the step:
authenticating the collected UAP data before transmitting the notification by accessing the at least one relational database and comparing the UAP data collected by the user device to UAP signature data within the relational database.

28. The method of claim 27, further includes the steps of:
generating UAP signatures from collected UAP data; and
storing a UAP data signature in at least one relational database.

29. The method of claim 28, further includes the step:
generating a UAP signature from authenticated collected data.

30. The method of claim 29, further includes the steps of:
comparing the signatures from a first user device to the signatures of a second user device and comparing the signatures to the stored authenticated UAP data and signatures in at least one relational database to improve the authentications of the UAP data and the subsequent creation of UAP signatures for any given sequence of UAP data-generating events having a common UAP signature associated with a plurality of users.

31. The method of claim 30, further includes the step:
generating a report of the authenticated collected UAP data and designated signatures received from a plurality of users corresponding to the UAP event.

32. The method of claim 31, further includes the step:
converting the reported data into user device manipulation instructions and transmitting those instructions to the users to assist them with the collection of additional UAP data.

33. The method of claim 32, further includes the step:
adjusting the user device camera settings in response to the common authenticated data and designated signatures.

34. The method of claim 33, further includes the steps of:
providing a UAP signature recognition algorithm capable of calculating signatures corresponding to UAP movement data and generating UAP movement predictions based on the calculations, and
triggering responsive adjustments to the camera settings based on the movement predictions.

35. The method of claim 34, further includes the steps of:
producing UAP tracking data responsive to the camera adjustments; and
adjusting the user device camera settings to track UAP movement in accordance with a set of UAP signatures corresponding to predictable UAP movements.

36. The method of claim 35, further includes the steps of:
providing at least one artificial intelligence (AI) algorithm responsive to non-analogous signatures and authenticated UAP data to anticipate unpredictable movements of the UAP being observed;
recording the unpredictable movements;
storing unpredictable movement signatures for a previously recorded UAP sighting event as predictable;
converting the newly stored movement signature into a set of tracking data enabling the user device camera settings to be adjusted to correspond to the tracking data; and
distributing the tracking data to the users.

37. The method of claim 36, further includes the step of:
generating a report from the tracking data when the user device UAP tracking data is authenticated as capable of tracking the UAP; and
transmitting the report to an independently configured responsive system capable of initiating an independent system response commensurate with its function.
